(19) United States
(12) Patent Application Publication
(10) Pub. No.: US 2008/0261556 A1
(43) Pub. Date: Oct. 23, 2008

(54) Mobile Phone Handset

(76) Inventor: Scott W. McLellan, Kempton, PA (US)

Correspondence Address: LESTER H. BIRNBAUM, 6 OAKMONT COURT, SIMPSONVILLE, SC, 29681, US

(21) Appl. No.: 10/573,575

(22) PCT Filed: Jun. 29, 2005
(86) PCT No.: PCT/US05/23039

§ 371 Date: Mar. 27, 2006

(51) Int. Cl. H04M 11/04

(52) U.S. Cl. 455/404.2

(57) ABSTRACT

A mobile phone set is provided that includes a personal locator beacon circuit. A microprocessor activates the circuit when emergency service is requested and no mobile service is available. The set can also include a global positioning satellite circuit so that location coordinates can be sent with the locator beacon.

### FIELD OF THE INVENTION

The present invention relates generally to mobile phones and, more particularly, to a mobile phone handset useful for emergency communications.

### BACKGROUND OF THE INVENTION

Mobile phones have become ubiquitous throughout the world. One of the more important functions of mobile phones is the ability to communicate to the appropriate authorities in the case of emergencies such as by dialing 911 in the United States. Newer mobile phones include a Global Positioning System (GPS) receiver that allows for transmissions of the handsets' position for uses such as enhanced 911 services so that a person in distress can be located automatically. A problem arises, however, if the individual is in an area where mobile phone service is not available.

It is, therefore, desirable to provide a mobile phone handset that will allow a person to be located in an emergency even in areas where there is no mobile phone service.

### SUMMARY OF THE INVENTION

In accordance one aspect, the invention is a mobile phone handset that includes a personal locator beacon (PLB) transmitter circuit. A microprocessor in the handset is configured to activate the PLB when emergency service is required, such as a user dialing 911, and when there is no mobile phone service available. Preferably, a Global Positioning System (GPS) receiver can be included in the handset, with the microprocessor configured to include GPS coordinates in the PLB transmission.

In accordance with another aspect, the invention is a method of requesting emergency service on a mobile phone handset including the steps of determining if mobile service is available, and activating a PLB transmitter circuit in the event that such service is unavailable. Preferably, GPS coordinates are included in a beacon transmitted by the PLB circuit.

It should be understood that in the context of this application, a PLB transmitter circuit is considered to be any circuit that is capable of transmitting a locator beacon, even if the mobile phone including the circuit is attached to a vehicle, such as in an OnStar system.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice in the industry, the various features of the drawing are not to scale. On the contrary, the dimensions of the various features are arbitrarily expanded or reduced for clarity. Included in the drawing are the following figures:

FIG. 1 is a schematic block diagram of a mobile phone handset in accordance with an embodiment of the invention;

FIG. 2 is a flow diagram illustrating the operation of a phone handset in accordance with the same embodiment; and

FIG. 3 is a schematic view of a PLB transmission system in accordance with the prior art.

### DETAILED DESCRIPTION OF THE INVENTION

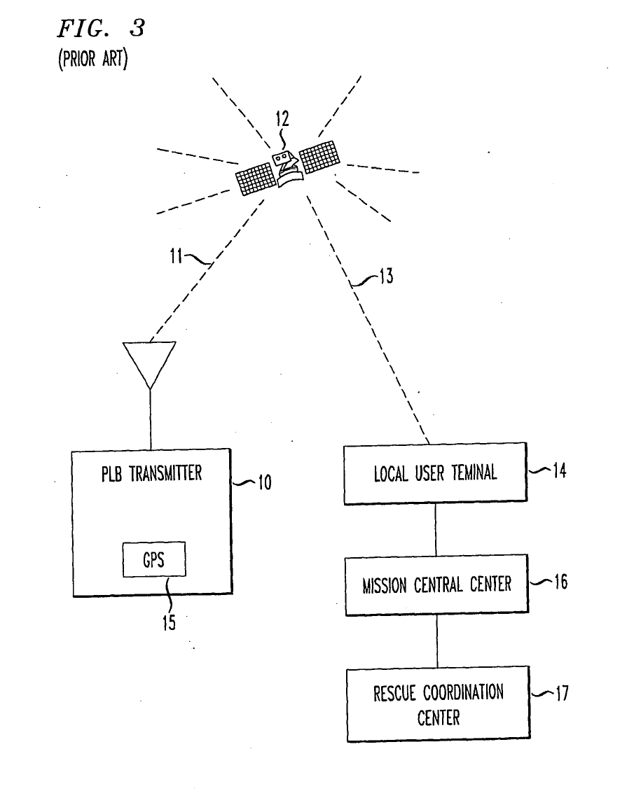

Referring now to the drawing, wherein like reference numerals refer to like elements throughout, FIG. 3 is a schematic view of a typical PLB transmission system. A PLB transmitter, 10, transmits a signal beacon, 11, which is typically at a frequency of 406 MHz. One such transmitter is manufactured by McMurdo Pains Wessex under the designation FastFind and FastFind Plus. Other transmitters include the MicroPLB manufactured by Wireless Concepts, and the 406 XS-2 and 406 XS-2 GPS manufactured by SERPE-IESM- KANNAD. (See, e.g., Ritter, “TLBs for Aviation”, The Aviation Consumer, p. 11-13 (July, 2003)). The signal is received by one of several Cospas-Sarsat satellites, 12, and then relayed by a beacon, 13, to a local user terminal, 14. The signal is forwarded to an appropriate mission control center, 16, and then to a rescue coordination center, 17, that dispatches search and rescue teams. Each PLB has a unique serial number that is transmitted with the beacon, 11, and the serial number must be registered with an appropriate regulatory body such as the National Oceanographic and Atmospheric Agency (NOAA) of the U.S. government or an equivalent governmental body outside the U.S. Thus, the local user terminal can determine the identity of the person in distress. Further, some models of the PLB transmitter include a GPS receiver, 15, so that GPS coordinates can be included with the beacon, 11, to identify the location of the distressed person. PLB transmitters are now required on certain aircraft and water vessels, and are available to individuals for personal use.

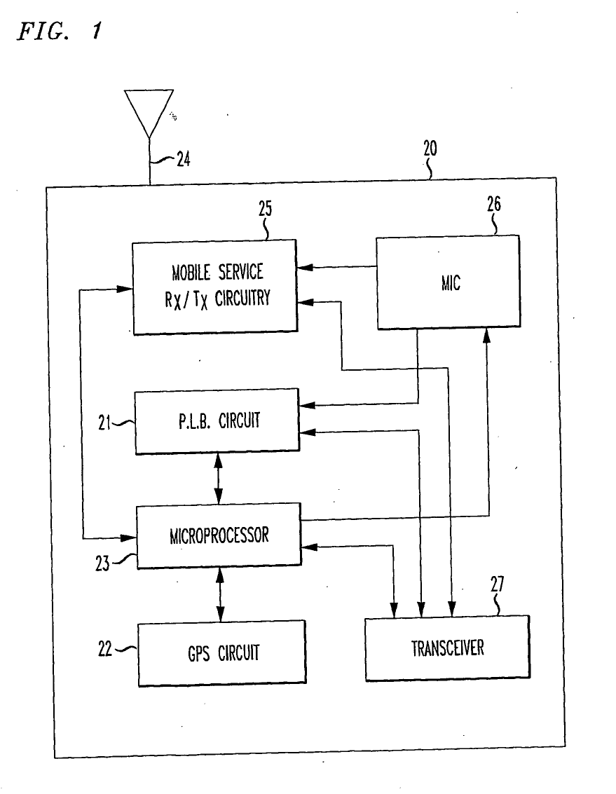

In accordance with a feature of the invention, the PLB technology is included in a mobile phone, 20, as shown in the schematic illustration of FIG. 1. The mobile phone, in addition to the conventional antenna, 24, mobile phone service (e.g., GSM, CDMA, etc.) receiver/transmitter circuitry, 25, and microprocessor, 23, includes a PLB circuit, 21, which is capable of transmitting a standardized locator beacon signal to a satellite as described above. The phone also preferably includes a GPS circuit, 22, for generating coordinates identifying the location of the phone, 20. The microprocessor, 23, controls the conventional phone service, and the PLB and GPS circuits. While the figure shows separate circuitry for the PLB, the microprocessor, the phone service, and the GPS circuits, one or more of these elements could be combined into a single chip. It will be appreciated that additional circuitry usually found in a mobile phone has been omitted for the sake of clarity.

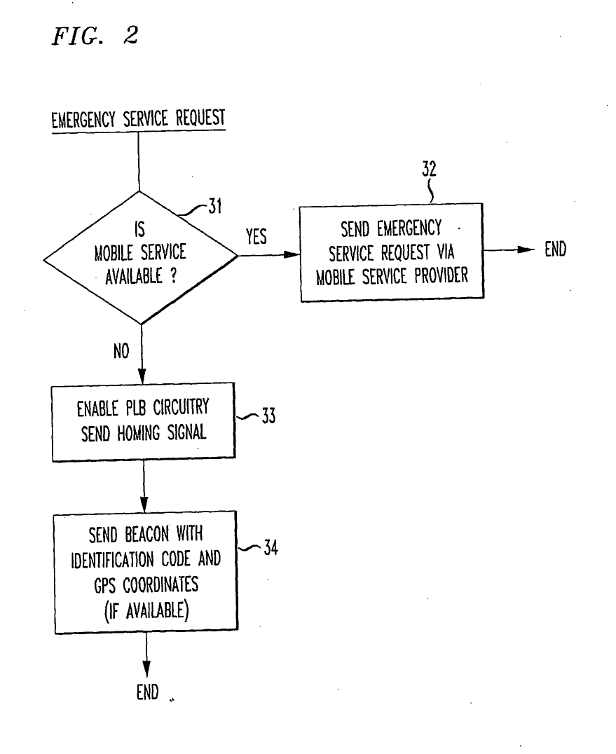

FIG. 2 illustrates a basic form of operation of the mobile phone of FIG. 2. The programming for this operation can be included in the microprocessor, 23, or stored in a separate memory element (not shown) coupled to the microprocessor. The microprocessor, 23 of FIG. 1, monitors the availability of mobile phone service in the area where the phone is located from the circuitry 25. A decision is made, illustrated by block 31, as to whether a mobile phone signal is available. If it is, the emergency service request is sent via the mobile phone user, as indicated by block 32, such as by dialing 911 in the United States. If there is no service and an emergency request is made, the microprocessor activates the PLB circuitry, 21, as indicated by block 33. Once activated, the PLB circuit will send out a beacon (11 of FIG. 1), as indicated by block 34, preferably through the mobile phone antenna, 24 of FIG. 2, to a satellite, 12, where the beacon will be relayed to a local user terminal, 14 of FIG. 1. The beacon will typically include an identification code, such as the serial number of the handset. Alternatively, the beacon could include the phone number of the handset as the identification code. The user terminal will have a record of the identification number of the mobile phone in order to determine the identity of the sender and initiate emergency services (e.g., search and rescue, ambulance, police, etc.) by forwarding the signal to an appropriate mission control center, 16. As also illustrated by block 34, the microprocessor can activate the GPS circuit, 22 of FIG. 1, to determine the mobile phone's GPS coordinates for inclusion in the beacon along with the identification number. The PLB circuit may also include a transmitter that generates a homing signal, usually at a frequency of 121.5 and/or 243 MHz, as illustrated by block 33, to permit a rescue team to locate the distressed person. Such a feature is included in commercially available PLB equipment such as those cited above.

Returning to FIG. 1, the handset may include further optional features, such as a microphone, 26, electrically coupled to the PLB circuit, 21, and controlled by the microprocessor, 23. Thus, the mobile phone may be configured via microprocessor, 23, to enable voice transmission from the handset via the 121.5/243 MHz homing signal. The handset may also include a short range transceiver, 27, electrically coupled to the mobile service circuitry, 25, the PLB circuit, 21, and the microprocessor, 23. If utilized in a motor vehicle, for example, the short range transceiver can receive emergency information, such as deployment of airbags, from a black box recorder in the vehicle and then transmit the information on the beacon signal generated by the PLB circuit, 21. The short range transceiver can be a Bluetooth or WiFi transceiver.

Although the invention has been described with reference to exemplary embodiments, it is not limited to those embodiments. Rather, the appended claims should, be construed to include other variants and embodiments of the invention which may be made by those skilled in the art without departing from the true spirit and scope of the present invention.

1: A mobile phone set comprising:
a personal locator beacon transmitter circuit which transmits a beacon that includes an identification code selected from a serial number and a phone number of the set; and
a microprocessor coupled to the circuit and configured to activate the circuit only when there is no mobile phone service available and the mobile phone user requests emergency service.

2: A phone set according to claim 1 further comprising a global positioning system receiver circuit coupled to the microprocessor, the microprocessor further configured to include location coordinates from the global positioning system receiver circuit with a beacon transmitted by the personal locator circuit.

3: A phone set according to claim 1 wherein the personal locator beacon circuit transmits a beacon at a frequency of approximately 406 MHz.

4: A phone set according to claim 3 wherein the personal locator beacon circuit also transmits a homing signal at a frequency selected from approximately 121.5 MHz and 243 MHz.

5: A phone set according to claim 4 further comprising a microphone coupled to the personal locator beacon transmitter circuit such that the homing signal includes voice transmission.

6-7. (canceled)

8: A phone set according to claim 1 further comprising a short range transceiver coupled to the personal locator beacon transmitter circuit and the microprocessor such that the locator beacon circuit transmits a beacon that includes emergency information received from the short range transceiver.

9. A method of requesting emergency service on a mobile phone handset comprising the steps of:
determining if mobile service is available: and
activating a personal locator beacon transmitter circuit in the event that such service is unavailable which circuit transmits a beacon that includes an identification code selected from a serial number and phone number of the handset.

10: The method according to claim 9 wherein the transmitter circuit transmits a beacon that includes global positioning system location coordinates.

11-12. (canceled)

13: The method according to claim 9 wherein the transmitter circuit transmits a beacon at a frequency of approximately 406 MHz.

14: The method according to claim 9 wherein the transmitter circuit transmits a homing signal at a frequency selected from approximately 121.5 MHz and 243 MHz.

15: The method according to claim 14 wherein voice transmission is included with the homing signal.

16: The method according to claim 9 wherein the beacon signal includes emergency information received from a short range transceiver located in the handset.
